(19) United States
(12) Patent Application Publication
(10) Pub. No.: US 2015/0005054 A1
(43) Pub. Date: Jan. 1, 2015

(54) SYSTEM AND METHOD FOR FACILITATING GIFTING OF VIRTUAL ITEMS BETWEEN USERS IN A GAME

(71) Applicant: Kabam, Inc., San Francisco, CA (US)

(72) Inventors: Kellen Christopher SMALLEY, Pleasanton, CA (US); Stephanie K. Schultz, San Francisco, CA (US); Kenneth J. Go, San Francisco, CA (US)

(73) Assignee: KABAM, INC.

(21) Appl. No.: 13/933,096

(22) Filed: Jul. 1, 2013

(51) Int. Cl. A63F 13/12

(52) U.S. Cl. CPC A63F 13/12
USPC 463/25

(57) ABSTRACT

One aspect of the disclosure relates to facilitating gifting of virtual items between users in an online game. During different periods in the game, users may be awarded virtual items as awards. The system provides the opportunity to a user to gift awards to other users at the time they are distributed. The other users may include members of a common affiliation, other users that have friend or other relationships, and/or other. For example, the game may provide an option to a user to keep an award or to share at least a portion of the award with one or more other users. The one or more users may be selectable from a list presented to the user. This may provide an opportunity for social gifting and/or interaction in the online game if virtual items and/or currency are typically not transferrable between users.

### FIELD

The disclosure relates to facilitating gifting of virtual items between users in an online game.

### BACKGROUND

In various online games, players purchase in-game virtual items during game play. Users, who spend more, usually achieve higher goals in the game. Sometimes an unfair balance is created in the game by providing more virtual items to users who spend more money. In some situations, users become bored with spending money on themselves in the game.

### SUMMARY

One aspect of the disclosure relates to facilitating gifting of virtual items between users in an online game. During different periods in the game, users may be awarded virtual items as awards. The system provides the opportunity to a user to gift awards to other users at the time they are distributed. The other users may include members of a common affiliation, other users that have friend or other relationships, and/or other. For example, the game may provide an option to a user to keep an award or to share at least a portion of the award with one or more other users. The one or more users may be selectable from a list presented to the user. This may provide an opportunity for social gifting and/or interaction in the online game if virtual items and/or currency are typically not transferrable between users.

A system configured to facilitating gifting of virtual items between users in an online game may include one or more processors configured to execute compute program modules. The program modules may comprise a game module, a user module, an award module, a sharing module, a user valuation module, a distribution module, a group module, an activity assessment module, an interaction module, relationship module, a network module, and/or any other modules.

The game module may be configured to execute a game instance of a game space. The game instance may be used to facilitate presentation of views of the game space to users. The game instance may be configured to facilitate interaction of the users with the game space and/or each other by performing operations in the game instance in response to commands and/or any other input received from the users.

A user module may be configured to store inventories of items that are available to the users in the game space. The inventories may include a first inventory of items available to a first user in the game space. The items may include a first virtual item and/or any other item. A virtual item may be an item that can be used in the game instance by the user. For example, a virtual item may be used to assist a player's character, and/or in other ways. Examples of virtual items include, but are not limited to, resources, currency, valuables (money, valuable metals or gems, etc.), weapons, spell components, defense components, armor, mounts, pets, attire, power ups, and/or other items.

An award module may be configured to determine awards for distribution to users based on performance in in-game activities. The award module may be configured to determine a first award for distribution to a first set of users based on performance of the first set of users in a first in-game activity. The first set of one or more users may include a first user and/or any other user. The first award may include one or more virtual items for use within the game space.

Responsive to the determination of the first award, the sharing module may be configured to effectuate presentation of an option for the first user to select one or more other users to whom the first award should be provided within the game space. The award module may be further configured to determine the performance of in game activities based on one or more: completion of tasks, user power in game, amount of resources obtained, overall user rank, and/or other parameters.

The computer program modules may further comprise a group module configured to manage one or more affiliations within the game space. An individual affiliation comprising a discrete group of users with a relationship may have a functional significance within the game space. The affiliations may include a first affiliation to which the first user belongs.

A sharing module may be configured such that the option for the first user to select one or more other users to whom the first award may be provided may restrict selections to other users from the first affiliation and/or any other affiliation. The first set of one or more users may consist of other users in the first affiliation and/or any other affiliation. The first set of one or more users may be the first affiliation and/or any other affiliation. The sharing module may be configured such that the option for the first user to select one or more other users to whom the first award should be provided restricts selections to other users from the first affiliation and/or any other affiliation. The sharing module may be configured such that a ranking position held by the first user in the first alliance is a further condition to the option for the first user to select one or more other users to whom the first award may be provided being presented to the first user and/or any other user. The first set of one or more users may consist of the first user and/or any other user.

The computer program modules may further comprise an activity assessment module configured to assess relative contribution of individual users to performance of sets of users in in-game activities. The activity assessment module may be configured to assess a relative contribution of the first user to performance of the first set of one or more users in the first in-game activity. Provision of the option for the first user to select one or more other users to whom the first award may be provided is further based on the relative contribution of the first user to performance of the first set of one or more users in the first in-game activity.

A distribution module may be configured to provide the first award to users within the game space in accordance with selections of the first user. The distribution module may be configured to distribute the refunds upon conclusion of the event time period and/or during any other time.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an exemplary system configured to facilitate gifting of virtual items between users in an online game, according to an aspect of the invention.

FIG. 2 illustrates an exemplary method of facilitating gifting of virtual items between users in an online game, according to an aspect of the invention.

FIG. 3 illustrates an exemplary diagram of a user interface which facilitates gifting of virtual items between users in an online game, according to an aspect of the invention.

FIG. 4 illustrates an exemplary diagram of a user interface which facilitates gifting of virtual items between users in an online game, according to an aspect of the invention.

FIG. 5 illustrates an exemplary diagram of a user interface which facilitates gifting of virtual items between users in an online game, according to an aspect of the invention.

FIG. 6 illustrates an exemplary diagram of a user interface which facilitates gifting of virtual items between users in an online game, according to an aspect of the invention.

FIG. 7 illustrates an exemplary diagram of a user interface which facilitates gifting of virtual items between users in an online game, according to an aspect of the invention.

FIG. 8 illustrates an exemplary diagram of a user interface which facilitates gifting of virtual items between users in an online game, according to an aspect of the invention.

### DETAILED DESCRIPTION

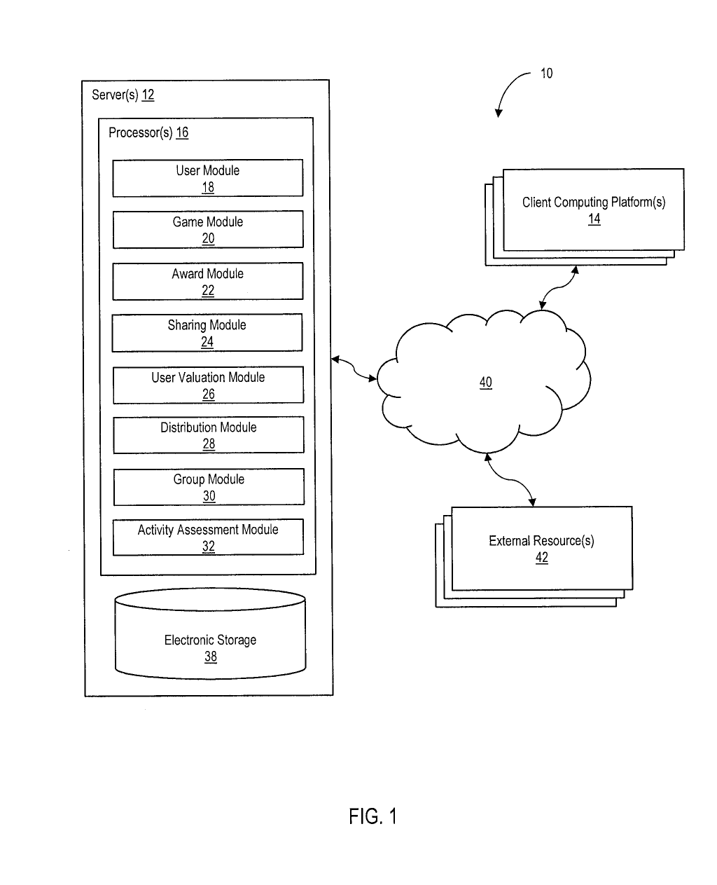

FIG. 1 illustrates a system 10 configured facilitate providing a tiered rebate system to a user of an online game, according to an aspect of the invention. The program modules may comprise a user module 18, a game module 20, an award module 22, a sharing module 24, a user valuation module 26, a distribution module 28, a group module 30, an activity assessment module 32, an interaction module, relationship module, a network module, and/or any other modules. In some implementations, system 10 may include a game server(s) 12. The game server(s) 12 may host a game space in which an online game takes place. The game server(s) 12 may be configured to communicate with one or more client computing platform(s) 14 according to a client/server architecture. The users may access system 10 and/or the virtual space via client computing platform(s) 14.

The game server(s) 12 may be configured to execute one or more computer program modules. The computer program modules may include one or more of a user module 18, a game module 20, an award module 22, a sharing module 24, a user valuation module 26, a distribution module 28, a group module 30, an activity assessment module 32, an interaction module, relationship module, a network module, and/or any other modules.

The user module 18 may be configured to access and/or manage one or more user profiles and/or user information associated with users of the system 10. The one or more user profiles and/or user information may include information stored by game server(s) 12, one or more of the client computing platform(s) 14, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual currency account information (e.g., related to currency held in credit for a user), relationship information (e.g., information related to relationships between users in the virtual space), virtual space usage information, demographic information associated with users, interaction history among users in the virtual space, information stated by users, purchase information of users, browsing history of users, a client computing platform identification associated with a user, a phone number associated with a user, and/or other information related to users.

The user module 18 may be configured to store inventories of virtual items including resources that are available to users in the virtual space. Various matters may be collected in an inventory. These matters may include, but are not limited to, virtual items, virtual resources, character attributes, character skills, and/or virtual currency. A virtual item may be an item that can be used in a virtual world to assist a player's character. Examples of virtual items include, but are not limited to, valuables (money, valuable metals or gems, etc.), weapons, spell components, defense components, and/or armor. A virtual resource may be a resource that can be used in the virtual world to create game attributes. Examples of virtual resources include wood, stone, herbs, water, ores, animals, monsters, bosses, non-player characters (NPCs), building materials, potions, etc. A character attribute may be any quality, trait, feature and/or characteristic a particular character can have. Character attributes may include, but are not be limited to: a character score, a virtual object, the physical appearance of a character, an emblem or mark, a synthetic voice, virtual currency, virtual help points or credits, the ability to join groups of other players at a later time, a score for subsequent matching of later game parameters, a relationship with another character, a genetic profile or makeup, a skill or skill level, and/or a ranking. Character skills may be game attributes inherent in or acquired by a player character during game play such as, but not limited to: the ability to cast (certain) spells, foretell the future, read minds, use (certain) weapons, cook, hunt, find herbs, assemble herbs into potions, mine, assemble objects into other objects, fly, and/or enchant other player characters.

The user maintains an inventory for the user's character in which virtual awards may be collected. The inventory may be accessed through an interface. As the character progresses through the game it may receive access to higher-level gear. Higher-level gear may be more powerful and/or effective within the game. This may include having parameters (e.g., hit points, attack strength, defense points, speed, etc.) that enhance the functionality of the gear in the game. The player may be able to review items within the player's inventory and equip the character with an item appropriate to the current game situation. Items may be dragged from the inventory to a preview window. As items are selected, they may appear either on or next to the character. For example, if the character is currently not wearing any armor and/or accessories, armor and accessories such as a cape may be added by accessing the character's inventory. Management of a character's inventory is a common game mechanic, and may lead to many hours of game play. Players may collect, trade, buy, fight over items, and/or perform other actions to add to their inventory. Games in different genres, such as science fiction, may incorporate items specific to that genre. For example, laser guns may be substituted in place of swords as the standard weapon used by characters within a science fiction-type game. The data describing clothing and other equipment or gear may be stored in the character record.

Players within the game may acquire virtual currency. In such games, the virtual currency might be represented by virtual coins, virtual cash, or by a number or value stored by the server for that player's benefit. Such virtual currency represents units of value for use in the online game system, and is analogous to legal currency. Virtual currency can be purchased in one or more actual cash or credit transactions by a player, where the legal currency is transferred using a credit/debit/charge card transaction conveyed over a financial network. A player may earn virtual currency by taking action in the game. For example, a player may be rewarded with one or more units of virtual currency after completing a task, quest, challenge, or mission within the game. For example, a farming game might reward 10 gold coins each time a virtual crop is harvested.

Virtual currency may be used to purchase one or more in-game assets or other benefits. For example, a player may be able to exchange virtual currency for a desired level, access, right, or item in an online game. In some implementations, legal currency can be used to directly purchase an in-game asset or other benefit. The player can select the desired in-game asset or other benefit. Once the necessary selections are made, the player can place the order to purchase the in-game asset or other benefit. This order is received by the game system, which can then process the order. If the order is processed successfully, an appropriate financial account associated with the player can be debited by the amount of virtual currency or legal currency needed to buy the selected in-game asset or other benefit.

Multiple types of virtual currency may be available for purchase from the game system operator. For example, an online game may have virtual gold coins and virtual cash. The different types of virtual currency may have different exchange rates with respect to legal currency and each other. For example, a player may be able to exchange $1 in legal currency for either 100 virtual gold coins or $2 in virtual cash, but virtual gold coins may not be exchanged for virtual cash. Similarly, where in-game assets and other benefits can be purchased with virtual currency, they may have different exchange rates with respect to the different types of virtual currency. For example, a player may be able to buy a virtual business object for $10 in virtual cash, but may not purchase the virtual business object for virtual gold coins alone. In some embodiments, certain types of virtual currency can be acquired by engaging in various in-game actions while other types of virtual currency can only be acquired by exchanging legal currency. For example, a player may be able to acquire virtual gold coins by selling virtual goods in a business, but can only acquire virtual cash by exchanging legal currency. Virtual cash may also be awarded for leveling up in the game.

The game module 20 may be configured to execute a game instance of a game space. The game instance may be used to facilitate presentation of views of the game space to users. The game instance may be configured to facilitate interaction of the users with the game space and/or each other by performing operations in the game instance in response to commands and/or any other input received from the users.

The game module 20 may be configured to implement the instance of the virtual space executed by the computer modules to determine state of the virtual space. The state may then be communicated (e.g., via streaming visual data, via object/position data, and/or other state information) from server(s) 12 to client computing platform(s) 14 for presentation to users. The state determined and transmitted to a given client computing platform(s) 14 may correspond to a view for a user character being controlled by a user via the given client computing platform(s) 14. The state determined and transmitted to a given client computing platform(s) 14 may correspond to a location in the virtual space. The view described by the state for the given client computing platform may correspond, for example, to the location from which the view is taken, the location the view depicts, and/or other locations, a zoom ratio, a dimensionality of objects, a point-of-view, and/or view parameters of the view. One or more of the view parameters may be selectable by the user.

The instance of the virtual space may comprise a simulated space that is accessible by users via clients (e.g., client computing platform(s) 14) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which state of the virtual space is determined by game module 20 is not intended to be limiting. The game module 20 may be configured to express the virtual space in a more limited, or more rich, manner. For example, views determined for the virtual space representing the state of the instance of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space executed by game module 20, users may control characters, objects, simulated physical phenomena (e.g., wind, rain, earthquakes, and/or other phenomena), and/or other elements within the virtual space to interact with the virtual space and/or each other. The user characters may include avatars. As used herein, the term “user character” may refer to an object (or group of objects) present in the virtual space that represents an individual user. The user character may be controlled by the user with which it is associated. The user controlled element(s) may move through and interact with the virtual space (e.g., non-user characters in the virtual space, other objects in the virtual space). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual space.

The users may participate in the instance of the virtual space by controlling one or more of the available user controlled elements in the virtual space. Control may be exercised through control inputs and/or commands input by the users through client computing platform(s) 14. The users may interact with each other through communications exchanged within the virtual space. Such communications may include one or more of textual chat, instant messages, private messages, voice communications, and/or other communications. Communications may be received and entered by the users via their respective client computing platform(s) 14. Communications may be routed to and from the appropriate users through server(s) 12 (e.g., through game module 20).

The interaction module may be configured to monitor interactions of the users with the virtual space and/or each other within the virtual space. This may include monitoring, for a given user, one or more of times at which the given user is logged in to the virtual space, areas of the virtual space the given user views or interacts with or in, other users the given user interacts with, the nature and/or content of interactions of the given user with other users, activities participated in within the virtual space, level, powers, or skill attained in the virtual space, inventory items obtained in the virtual space, and/or other interactions of the given user with the virtual space and/or other users. Some or all of the information generated by interaction module in monitoring the interactions of the users may be stored to the user profiles managed by user module 18.

At a given time, interaction module may determine a set of users that are currently engaged with the virtual space and/or a set of users that are currently not engaged with the virtual space. Being engaged with the virtual space may refer to being logged in to the virtual space, performing some action or interaction within the virtual space within some period of time (e.g., the last 2 minutes), and/or other taking some other action indicating ongoing and contemporaneous engagement with the virtual space.

The interaction module may be configured to determine, for individual users, an activity metric that indicates an activity level within the virtual space. The activity metric may be determined based on one or more of log in frequency, amount of time logged in to the virtual space within a rolling time period (e.g., over the last day, week, month, or other rolling time period), average amount of time logged in to the virtual space over some length of time (e.g., per day, per week, and/or other length of time), average log in session time over a rolling time period, number of inter-user communications over a length of time, number of inter-user communications per log in, number of relationships with other users in the virtual space, number of new relationships with other users in the virtual space within a rolling time period, amount of real world money spent in the virtual space, and/or other activity parameters.

Network module of the game server(s) 12 may be configured to maintain a connection to the one or more client computing platform(s) 14. For example, the network module may maintain one or more communication lines or ports to enable connection and/or exchange of information with a network 40 and/or other computing platform(s) 14. Information such as state information, game state and game logic may be communicated via network module. The network module may be configured to receive information from the client computing platform(s) 14 as well.

A store module may be configured to present a store interface to the users. The store interface may present offers to users to buy item instances of virtual items. The virtual items may include a first virtual item and/or any other item. A virtual item may be an item that can be used in the game instance by the user. For example, a virtual item may be used to assist a player's character, and/or in other ways. Examples of virtual items include, but are not limited to, resources, currency, valuables (money, valuable metals or gems, etc.), weapons, spell components, defense components, armor, mounts, pets, attire, power ups, and/or other items.

A store module may be configured to effectuate presentation to the users of offers to purchase resources. The offers may include a first offer for the first user to purchase a first set of one or more virtual items. The virtual items may include a virtual good, a virtual currency, and/or other virtual items as described above. For example, the store module may be configured such that the offers presented to the first user may be restricted to offers having prices in a first price range. The first price range may be determined based on the user metric for the first user, and/or the user metric for other users. The store module may be configured such that the first price range may change as participation by the first user in the game causes the user metric for the first user to change. The store module may be configured such that the first price range may be bounded by one or more both of a minimum value and/or a maximum value. The store module may be configured such that the offers having prices below the minimum value may not be available for purchase by the first user. The store module may be configured such that offers having prices above the maximum value may be locked. This may mean the offers having prices above the maximum value may be unavailable for purchase by the first user independent from whether the first user has consideration sufficient to purchase such offers. Such offers may become unlocked as the maximum value of the price range is adjusted above the prices of such offers.

For example, players' experience with pricing of in-game goods may be associated with their progress in the game. In some implementations, the higher the level of the player, the lower the in-game goods may cost. Depending on the level of the player, the goods available to the player may change. Overall, the more the player advances in the game, new items may be unlocked to the player for purchase. Goods previously provided to the player for purchase may or may not be accessible to the player depending on the player's level.

An award module 22 may be configured to determine awards for distribution to users based on performance in in-game activities. The award module 22 may be configured to determine a first award for distribution to a first set of users based on performance of the first set of users in a first in-game activity. The first set of one or more users may include a first user and/or any other user. The first award may include one or more virtual items for use within the game space.

Responsive to the determination of the first award, the sharing module may be configured to effectuate presentation of an option for the first user to select one or more other users to whom the first award should be provided within the game space. The award module may be further configured to determine the performance of in game activities based on one or more: completion of tasks, user power in game, amount of resources obtained, overall user rank, and/or other parameters.

Tasks shall include, but not be limited to: completing all or part of a mission; playing for a certain period of time; winning a match against another player character or computer generated character; reaching a certain level or score; using or obtaining an ability or technology; kill/death ratios; obtaining, creating or modifying an object; solving a puzzle; accuracy with weapons; effective use of the proper weapon; killing a certain character/creature; getting through or to a certain geographic area; decreasing or increasing Karma Points; getting, buying, exchanging or learning a new skill or player attribute; having a child; getting married; obtaining, buying, trading, producing or developing raw materials; producing goods or services; earning income; earning a higher rank in an army; winning an election among two or more player characters; achieving deity or other status; improving player character status or caste; assisting other player characters with any of the above; speed of accomplishing or changing the rate or trends of any or all of the above.

User power in a game may be determined by any type of user metric calculation. The user metric may quantify one or more of a progress within the game, a power level within the game, a skill level within the game, a level of virtual technology advancement within the game, success within the game as a whole or within certain types of gameplay (e.g., player-versus-player gameplay, player-versus-environment gameplay, harvesting gameplay, and/or other gameplay types), and/or other aspects. A metric can be classified as a status metric or a predictive metric. A status metric characterizes behavioral information of a set of on-line entities where the behavioral information is related to at least one activity of the on-line entities within the persistent virtual environment. Example status metrics include, without limitation, a prominence metric, a centrality degree metric, a cohesive subgroup metric, a group level equivalence metric, a leadership metric, a strength of ties metric, an interactivity metric, a topic of interaction metric, a role metric, a social accounting metric, a game-play metric, a modeling metric, and an interaction topic metric as well as other metrics. These metrics are subsequently briefly described.

A predictive metric can, for example, evaluate the change in a status metric over time. Example predictive metrics include, without limitation: a churn metric, a compatibility metric, a scheduling metric, a content consumption metric, an environmental balance metric, a survival metric, and an economic metric. “Churn” metrics predict the probability of a player leaving the persistent virtual environment, based on the player's past interaction patterns. Compatibility metrics indicate whether or not a player's play style will match a proposed player association or whether the player's play style matches that of the player association to which he/she is a member. Scheduling metrics predict the probability of a player being available for a future joint activity, so that such activities can be planned in advance. Content consumption metrics predict when players will have exhausted the persistent virtual environment's resources, in order to plan timely expansions to the persistent virtual environment. Environmental balance metrics predict the effects of a design change on the persistent virtual environment, such as removing a given “profession” or certain items from the persistent virtual environment. Economic metrics predict inflation, trade volume, and other variables in order to maintain the balance of trade in the persistent virtual environment. The survival metric indicates the health of a player association.

The predictive metrics can include those that develop a time-series of single or combinations of status metrics (weighted or un-weighted) that represent trends; metrics that represent heuristically determined conditions relevant to the predicted health of the persistent virtual environment; metrics based on a vector of attributes representing characteristics of the on-line entity such that the vectors can be used to classify on-line entities and to determine the characteristics of successful on-line entities; and to determine whether on-line entities have characteristics that are progressing toward or away from the characteristics of successful online entities.

The classification of the on-line entities can utilize a Bayesian network, spectral analysis, nearest neighbor techniques or any other classification mechanism. The predictive metrics can timely measure the social aspects of player interactions in the persistent virtual environment, and measure and/or monitor the health of the online player community in a persistent virtual environment. By using the predictive metrics, the MMOG provider can alter the persistent virtual environment to encourage desired social interactions and to discourage less desired social interactions.

User resources may be any in game matter acquired by the user. Various matters may be collected in an inventory. These matters may include, but are not limited to, virtual items, virtual resources, character attributes, and/or character skills. A virtual item may be an item that can be used in a virtual world to assist a player's character. Examples of virtual items include, but are not limited to, valuables (money, valuable metals or gems, etc.), weapons, spell components, defense components, and/or armor. A virtual resource may be a resource that can be used in the virtual world to create game attributes. Examples of virtual resources include wood, stone, herbs, water, ores, animals, monsters, bosses, NPCs, building materials, potions, etc. A character attribute may be any quality, trait, feature and/or characteristic a particular character can have. Character attributes may include, but are not be limited to: a character score, a virtual object, the physical appearance of a character, an emblem or mark, a synthetic voice, virtual currency, virtual help points or credits, the ability to join groups of other players at a later time, a score for subsequent matching of later game parameters, a relationship with another character, a genetic profile or makeup, a skill or skill level, and/or a ranking. Character skills may be game attributes inherent in or acquired by a player character during game play such as, but not limited to: the ability to cast (certain) spells, foretell the future, read minds, use (certain) weapons, cook, hunt, find herbs, assemble herbs into potions, mine, assemble objects into other objects, fly, and/or enchant other player characters.

The user maintains an inventory for the user's character in which virtual awards may be collected. The inventory may be accessed through an interface. As the character progresses through the game it may receive access to higher-level gear. Higher-level gear may be more powerful and/or effective within the game. This may include having parameters (e.g., hit points, attack strength, defense points, speed, etc.) that enhance the functionality of the gear in the game. The player may be able to review items within the player's inventory and equip the character with an item appropriate to the current game situation. Items may be dragged from the inventory to a preview window. As items are selected, they may appear either on or next to the character. For example, if the character is currently not wearing any armor and/or accessories, armor and accessories such as a cape may be added by accessing the character's inventory. Management of a character's inventory is a common game mechanic, and may lead to many hours of game play. Players may collect, trade, buy, fight over items, and/or perform other actions to add to their inventory. Games in different genres, such as science fiction, may incorporate items specific to that genre. For example, laser guns may be substituted in place of swords as the standard weapon used by characters within a science fiction-type game. The data describing clothing and other equipment or gear may be stored in the character record.

User rankings may be determined based on any aspect of game by which a player character's performance can be measured. Game parameters shall include, but not be limited to: completing all or part of a mission; playing for a certain period of time; winning a match against another player character or computer generated character; reaching a certain level or score; using or obtaining an ability or technology; kill/death ratios; obtaining, creating or modifying an object; solving a puzzle; accuracy with weapons; effective use of the proper weapon; killing a certain character/creature; getting through or to a certain geographic area; decreasing or increasing Karma Points; getting, buying, exchanging or learning a new skill or player attribute; having a child; getting married; obtaining, buying, trading, producing or developing raw materials; producing goods or services; earning income; earning a higher rank in an army; winning an election among two or more player characters; achieving deity or other status; improving player character status or caste; assisting other player characters with any of the above; speed of accomplishing or changing the rate or trends of any or all of the above.

The computer program modules may further comprise a group module configured to manage one or more affiliations within the game space. An individual affiliation comprising a discrete group of users with a relationship may have a functional significance within the game space. The affiliations may include a first affiliation to which the first user belongs.

A sharing module may be configured such that the option for the first user to select one or more other users to whom the first award may be provided may restrict selections to other users from the first affiliation and/or any other affiliation. The first set of one or more users may consist of other users in the first affiliation and/or any other affiliation. The first set of one or more users may be the first affiliation and/or any other affiliation. The sharing module may be configured such that the option for the first user to select one or more other users to whom the first award should be provided restricts selections to other users from the first affiliation and/or any other affiliation. The sharing module may be configured such that a ranking position held by the first user in the first alliance is a further condition to the option for the first user to select one or more other users to whom the first award may be provided being presented to the first user and/or any other user. The first set of one or more users may consist of the first user and/or any other user.

The sharing module provides the opportunity to gift things to a chosen alliance, and/or any other group including friends or people the user includes in a list. This module and any other module may be implemented at both a server level and a game level. In some implementations, users who participate at the highest level may determine how to split the gift up. In some implementations, the gift will be made by the users who spend the most, so they can choose to give the gift to any group of people. Thus, incentivizing user who do pay a lot in game can help out the users that don't spend much. Users who do pay are willing to pay more so they can help other user's progress in the game.

The computer program modules may further comprise an activity assessment module configured to assess relative contribution of individual users to performance of sets of users in in-game activities. The activity assessment module may be configured to assess a relative contribution of the first user to performance of the first set of one or more users in the first in-game activity. Provision of the option for the first user to select one or more other users to whom the first award may be provided is further based on the relative contribution of the first user to performance of the first set of one or more users in the first in-game activity.

A distribution module may be configured to provide the first award to users within the game space in accordance with selections of the first user. The distribution module may be configured to distribute the refunds upon conclusion of the event time period and/or during any other time.

The game server(s) 12, client computing platform(s) 14, and/or external resource(s) 42 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which game server(s) 12, client computing platform(s) 14, and/or external resource(s) 42 may be operatively linked via some other communication media.

Game server(s) 12 may include electronic storage 34, one or more processors 16, and/or other components. Game server(s) 12 may include communication lines, or ports to enable the exchange of information with a network 46 and/or other computing platforms 14. Illustration of game server(s) 12 in FIG. 1 is not intended to be limiting. Game server(s) 12 may include a plurality of hardware, software, and/or firmware components operating together to provide the functionality attributed herein to game server(s) 12. For example, game server(s) 12 may be implemented by a cloud of computing platforms operating together as game server(s) 12.

Electronic storage 34 may comprise non-transitory storage media that electronically stores information. The electronic storage media of Electronic storage 34 may include one or both of system storage that is provided integrally (i.e., substantially non-removable) with game server(s) 12 and/or removable storage that is removably connectable to game server(s) 12 via, for example, a port (e.g., a USB port, a firewire port, etc.) or a drive (e.g., a disk drive, etc.). Electronic storage 34 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 34 may include one or more virtual storage resources (e.g., cloud storage, a virtual private network, and/or other virtual storage resources). Electronic storage 34 may store software algorithms, information determined by processor 16, information received from game server(s) 12, information received from client computing platforms 14, and/or other information that enables game server(s) 12 to function as described herein.

Processor(s) 16 is configured to provide information processing capabilities in game server(s) 12. As such, processor 16 may include one or more of a digital processor, an analog processor, a digital circuit designed to process information, an analog circuit designed to process information, a state machine, and/or other mechanisms for electronically processing information. Although processor(s) 16 is shown in FIG. 1 as a single entity, this is for illustrative purposes only. In some implementations, processor(s) 16 may include a plurality of processing units. These processing units may be physically located within the same device, or processor(s) 16 may represent processing functionality of a plurality of devices operating in coordination. The processor(s) 16 may be configured to execute modules 18, 20, 22, 26, 28, 30, and/or 32. Processor(s) 16 may be configured to execute modules 18, 20, 22, 26, 28, 30, and/or 32 by software; hardware; firmware; some combination of software, hardware, and/or firmware; and/or other mechanisms for configuring processing capabilities on processor(s) 16. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 18, 20, 22, 26, 28, 30, and/or 32 are illustrated in FIG. 1 as being implemented within a single processing unit, in implementations in which processor includes multiple processing units, one or more of modules 18, 20, 22, 26, 28, 30, and/or 32 may be implemented remotely from the other modules. The description of the functionality provided by the different modules 18, 20, 22, 26, 28, 30, and/or 32 described below is for illustrative purposes, and is not intended to be limiting, as any of modules 18, 20, 22, 26, 28, 30, and/or 32 may provide more or less functionality than is described. For example, one or more of modules 18, 20, 22, 26, 28, 30, and/or 32 may be eliminated, and some or all of its functionality may be provided by other ones of modules 18, 20, 22, 26, 28, 30, and/or 32. As another example, processor 16 may be configured to execute one or more additional modules that may perform some or all of the functionality attributed below to one of modules 18, 20, 22, 26, 28, 30, and/or 32.

A given client computing platform(s) 14 may include one or more processors configured to execute computer program modules. The computer program modules may be configured to enable an expert or user associated with the given client computing platform(s) 14 to interface with system 10, game server(s) 12, and/or external resources 36, and/or provide other functionality attributed herein to client computing platform(s) 14. By way of non-limiting example, the given client computing platform(s) 14 may include one or more of a desktop computer, a laptop computer, a handheld computer, a tablet computing platform, a NetBook, a Smartphone, a gaming console, and/or other computing platforms.

External resource(s) 42 may include sources of information, hosts and/or providers of virtual spaces outside of system 10, external entities participating with system 10, and/or other resources. In some implementations, some or all of the functionality attributed herein to external resources 36 may be provided by resources included in system 10.

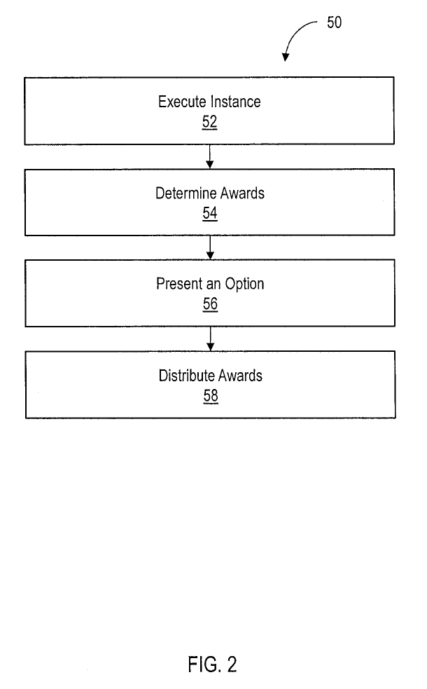

FIG. 2 illustrates a method 50 configured to facilitate gifting of virtual items between users in an online game, according to an aspect of the invention. The operations of method 50 presented below are intended to be illustrative. In some embodiments, method 50 may be accomplished with one or more additional operations not described, and/or without one or more of the operations discussed. Additionally, the order in which the operations of method 50 are illustrated in FIG. 2 and described below is not intended to be limiting.

In some embodiments, method 50 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 50 in response to instructions stored electronically on an electronic storage medium. The one or more processing devices may include one or more devices configured through hardware, firmware, and/or software to be specifically designed for execution of one or more of the operations of method 50.

At an operation 52, an instance of a virtual space may be executed. In some implementations, operation 52 may be performed by a game module the same as or similar to game module 20 (shown in FIG. 1 and described above).

At an operation 54, the executed instance of the virtual space may be implemented to determine awards. A first award for distribution to a first set of users based on performance of the first set of users in a first in-game activity may be determined. In some implementations, operation 54 may be performed by an award module the same as or similar to award module 22 (shown in FIG. 1 and described above).

At an operation 56, an option may be presented to a user. Presentation of an option for the first user to select one or more other users to whom the first award should be provided within the game space may be offered to a user. In some implementations, operation 56 may be performed by a sharing module the same as or similar to sharing module 24 (shown in FIG. 1 and described above).

At an operation 58, awards may be distributed to the users. In some implementations, operation 58 may be performed by a distribution module the same as or similar to distribution module 28 (shown in FIG. 1 and described above).

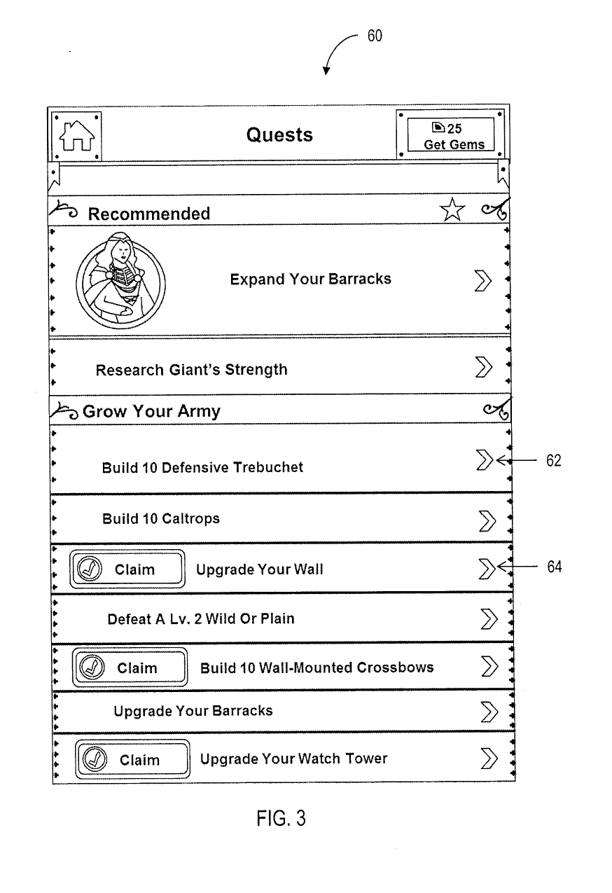

FIG. 3 illustrates an exemplary diagram of a user interface 60 which facilitates gifting of virtual items between users in an online game, according to an aspect of the invention. As shown, user interface 60 may assign various tasks 62 to the users. Tasks shall include, but not be limited to: completing all or part of a mission; playing for a certain period of time; winning a match against another player character or computer generated character; reaching a certain level or score; using or obtaining an ability or technology; kill/death ratios; obtaining, creating or modifying an object; solving a puzzle; accuracy with weapons; effective use of the proper weapon; killing a certain character/creature; getting through or to a certain geographic area; decreasing or increasing Karma Points; getting, buying, exchanging or learning a new skill or player attribute; having a child; getting married; obtaining, buying, trading, producing or developing raw materials; producing goods or services; earning income; earning a higher rank in an army; winning an election among two or more player characters; achieving deity or other status; improving player character status or caste; assisting other player characters with any of the above; speed of accomplishing or changing the rate or trends of any or all of the above.

Upon completion of the task, the user interface 60 may present an offer to the user to claim the award 64. The user may have the option to keep the award or share the award with the user's alliance or any individual and/or group the user chooses to share their award. The user may be provided the opportunity to gift things to a chosen alliance, and/or any other group including friends or individuals the user includes in a list.

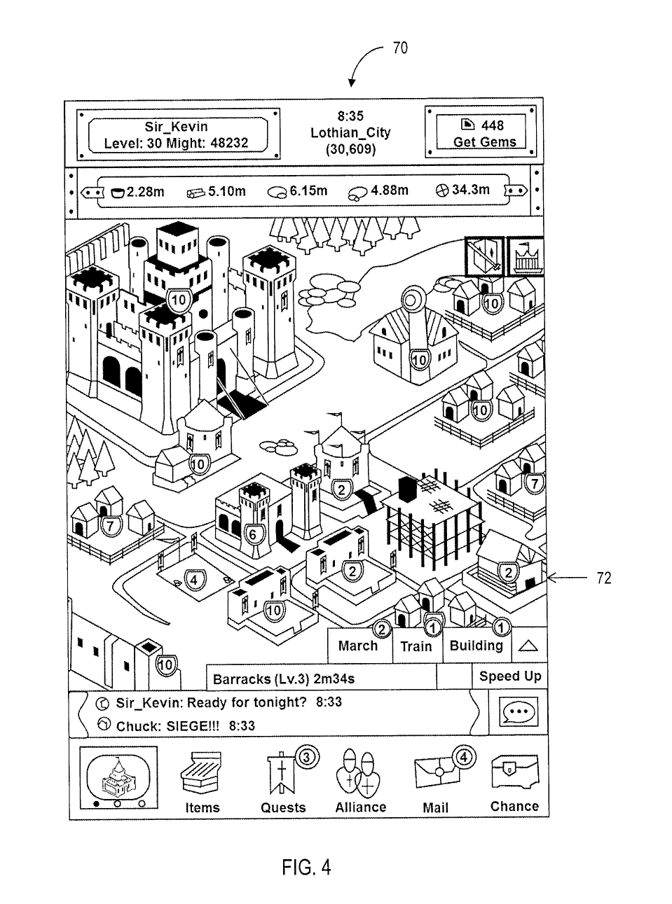

FIG. 4 illustrates an exemplary diagram of a user interface 70 which facilitates gifting of virtual items between users in an online game, according to an aspect of the invention. The user may be required to accomplish various in-game tasks to achieve an award. In some implementations, the task may be to upgrade a building 72 in the virtual game.

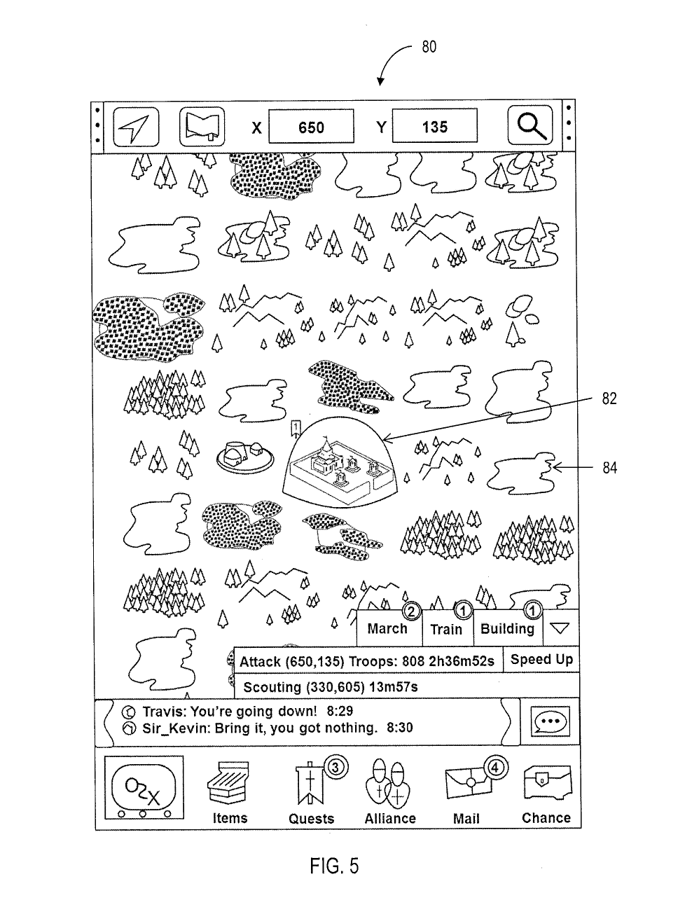

FIG. 5 illustrates an exemplary diagram of a user interface 80 which facilitates gifting of virtual items between users in an online game, according to an aspect of the invention. The user 82 may be required to accomplish various in-game tasks to achieve an award. In some implementations, the task may be to defeat and/or conquer a wild and/or plain 84 in the virtual game.

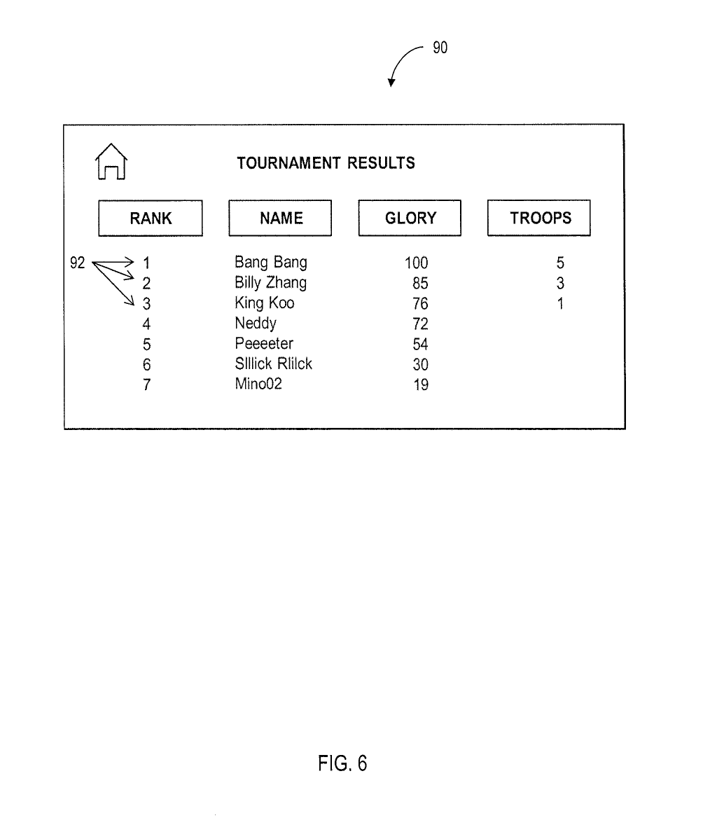

FIG. 6 illustrates an exemplary diagram of a user interface 90 which facilitates gifting of virtual items between users in an online game, according to an aspect of the invention. The user may be required to accomplish various in-game tasks to achieve an award. In some implementations, the task may be to achieve a certain rank and/or level in a tournament. In some implementations, multiple users may be presented the option of keeping or sharing the award. For example, the top three users 92 may be provided the option to keep or share the awards and/or prizes with other users. In some implementations, only an individual achieving a certain rank may be provided the option to keep or share the award with other members. Tournaments may refer to a video game tournament wherein there is a predetermined goal and a plurality of players play to achieve a same goal wherein a known number of players or of teams of players is expected to win the tournament.

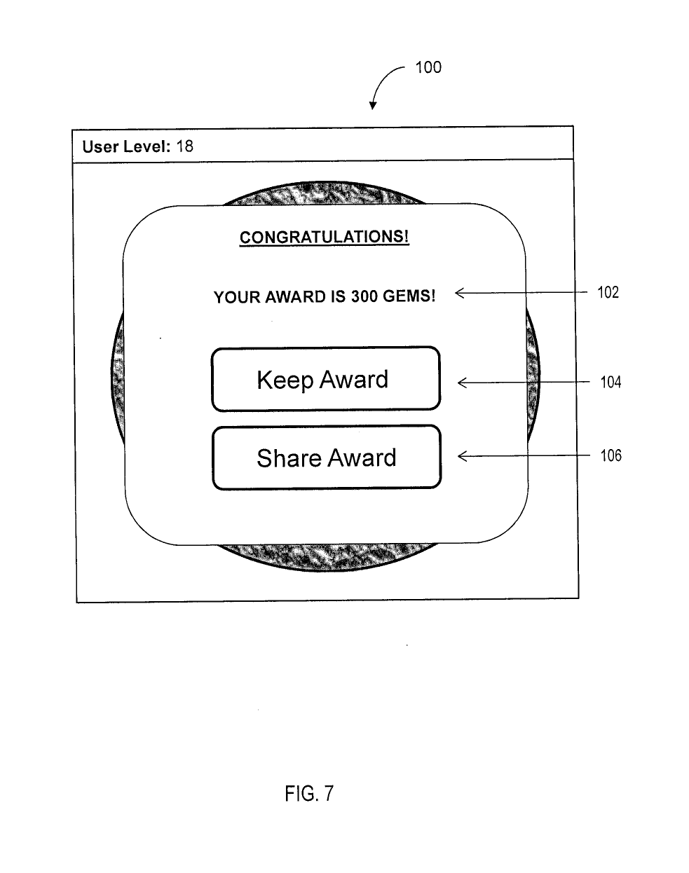

FIG. 7 illustrates an exemplary diagram of a user interface 100 which facilitates gifting of virtual items between users in an online game, according to an aspect of the invention. In some implementations, a single and/or multiple users may be presented the option of keeping 104 or sharing 106 the award 102. In some implementations, the users may be allowed the option to enter into a list the other users they would like to share the award with. In some implementations, the users may be allowed to select from a preexisting list of other users they may be allowed to share their award with. The users may be provided the option to have the system randomly select various users with whom to share the award.

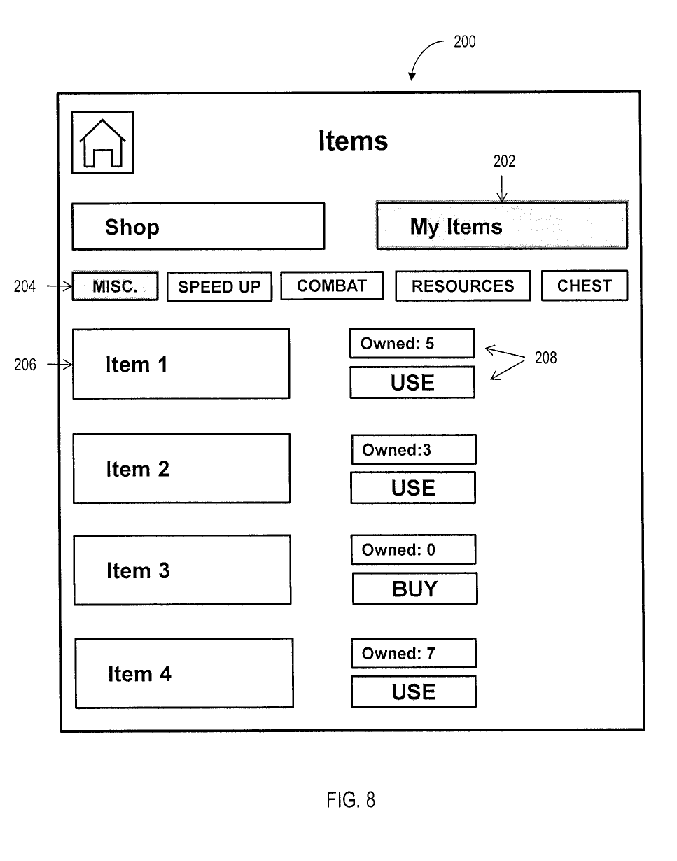

FIG. 8 illustrates an exemplary diagram of a user interface 200 which facilitates gifting of virtual items between users in an online game, according to an aspect of the invention. As shown, user interface 200 enables a user to purchase and/or win virtual items for in-game use. In some implementations, the user may select the my items tab 202, and select from a category 204 of virtual in-game goods to purchase. In some implementations, the categories may include one or more: miscellaneous, speed up, combat, resources, chest, and/or any other category. Each category contains lists of items 206 for a user to purchase and/or have stored in their inventory. The user interface 200 displays the cost of each item to the user, and allows purchase and/or use of the item 208. For each user, a different set of items 206 may be available in their personal inventories.

It would be understood by one of ordinary skill in the art that the user interfaces may not be limited to the embodiment illustrated in FIGS. 3, 4, 5, 6, 7 and 8. The user interfaces may be associated with any objective, activity, action, or a combination thereof.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for facilitating gifting of virtual items between users in an online game, the system comprising:
one or more processors configured to execute computer program modules, the computer program modules comprising:
a game module configured to execute a game instance of a game space, and to facilitate presentation of views of the game space to users to enable interaction of the users with the game space and/or each other by performing operations in the game space in response to commands received from the users, the users including a first user;
an award module configured to determine awards for distribution to users based on performance in in-game activities such that the award module is configured to determine a first award for distribution to a first set of users based on performance of the first set of users in a first in-game activity, wherein the first set of one or more users includes the first user, and wherein the first award includes one or more virtual items for use within the game space;
a sharing module, responsive to the determination of the first award, the sharing module is configured to effectuate presentation of an option for the first user to select one or more other users to whom the first award should be provided within the game space; and
a distribution module configured to provide the first award to users within the game space in accordance with selections of the first user.

2. The system of claim 1, wherein the award module is further configured to determine the performance of in game activities based on one or more: completion of tasks, user power in game, amount of resources obtained, overall user rank.

3. The system of claim 1, wherein the computer program modules further comprise a group module configured to manage one or more affiliations within the game space, an individual affiliation comprising a discrete group of users with a relationship having a functional significance within the game space, wherein the affiliations include a first affiliation to which the first user belongs.

4. The system of claim 3, wherein the sharing module is configured such that the option for the first user to select one or more other users to whom the first award should be provided restricts selections to other users from the first affiliation.

5. The system of claim 3, wherein the first set of one or more users consists of other users in the first affiliation.

6. The system of claim 5, wherein the first set of one or more users is the first affiliation.

7. The system of claim 5, wherein the sharing module is configured such that the option for the first user to select one or more other users to whom the first award should be provided restricts selections to other users from the first affiliation.

8. The system of claim 7, wherein the sharing module is configured such that a ranking position held by the first user in the first alliance is a further condition to the option for the first user to select one or more other users to whom the first award should be provided being presented to the first user.

9. The system of claim 1, wherein the first set of one or more users consists of the first user.

10. The system of claim 1, wherein the computer program modules further comprise an activity assessment module configured to assess relative contribution of individual users to performance of sets of users in in-game activities such that the activity assessment module is configured to assess a relative contribution of the first user to performance of the first set of one or more users in the first in-game activity, and wherein provision of the option for the first user to select one or more other users to whom the first award should be provided is further based on the relative contribution of the first user to performance of the first set of one or more users in the first in-game activity.

11. A computer implemented method for facilitating gifting of virtual items between users in an online game, the method being implemented in a computer system that includes one or more physical processors executing computer program modules, the method comprising:
executing an instance of a game space, and implementing the instance of the game space to facilitate participation by the users in an online game that takes place in the game space, wherein facilitating interaction of the users with the game space and/or each other by performing operations in the game space in response to commands received from the users, the users including a first user;
determining awards for distribution to users based on performance in in-game activities configured to determine a first award for distribution to a first set of users based on performance of the first set of users in a first in-game activity, wherein the first set of one or more users includes the first user, and wherein the first award includes one or more virtual items for use within the game space;
responsive to the determination of the first award, effectuating presentation of an option for the first user to select one or more other users to whom the first award should be provided within the game space; and
providing the first award to users within the game space in accordance with selections of the first user.

12. The method of claim 1, further configured to determine the performance of in game activities based on one or more: completion of tasks, user power in game, amount of resources obtained, overall user rank.

13. The method of claim 1, further configured to manage one or more affiliations within the game space, an individual affiliation comprising a discrete group of users with a relationship having a functional significance within the game space, wherein the affiliations include a first affiliation to which the first user belongs.

14. The method of claim 13, configured such that the option for the first user to select one or more other users to whom the first award should be provided restricts selections to other users from the first affiliation.

15. The method of claim 13, wherein the first set of one or more users consists of other users in the first affiliation.

16. The method of claim 15, wherein the first set of one or more users is the first affiliation.

17. The method of claim 15, configured such that the option for the first user to select one or more other users to whom the first award should be provided restricts selections to other users from the first affiliation.

18. The method of claim 17, configured such that a ranking position held by the first user in the first alliance is a further condition to the option for the first user to select one or more other users to whom the first award should be provided being presented to the first user.

19. The method of claim 11, wherein the first set of one or more users consists of the first user.

20. The method of claim 11, further configured to assess relative contribution of individual users to performance of sets of users in in-game activities such that assessing a relative contribution of the first user to performance of the first set of one or more users in the first in-game activity, and wherein provision of the option for the first user to select one or more other users to whom the first award should be provided is further based on the relative contribution of the first user to performance of the first set of one or more users in the first in-game activity.
